(19) United States
(12) Patent Application Publication
(10) Pub. No.: US 2021/0181732 A1
(43) Pub. Date: Jun. 17, 2021

(54) CONTROL METHOD, CONTROL APPARATUS, AND MECHANICAL EQUIPMENT

(71) Applicant: CANON KABUSHIKI KAISHA, Tokyo (JP)

(72) Inventor: Kazuhisa Sadazuka, Kanagawa (JP)

(21) Appl. No.: 17/121,561

(22) Filed: Dec. 14, 2020

(30) Foreign Application Priority Data
Dec. 17, 2019 (JP) 2019-227419

(51) Int. Cl. G05B 23/02

(52) U.S. Cl. CPC G05B 23/0254

(57) ABSTRACT

A control method includes obtaining, in a first period, a measurement value related to mechanical equipment in a first state, specifying a period in which the mechanical equipment is in an operating state in the first period, by using the measurement value and profile information of the measurement value corresponding to a time when the mechanical equipment is in the operating state, and extracting, as data for machine learning, a feature value based on the measurement value corresponding to the specified period which is in the first period and in which the mechanical equipment is in the operating state.

### BACKGROUND

### Field of the Disclosure

The present disclosure relates to a control method, a control apparatus, mechanical equipment including the control apparatus, and a non-transitory computer-readable recording medium.

### Description of the Related Art

An operation status of mechanical equipment can change every moment depending on status change of a constituent part or the like. In the description below, an operation status within an allowable range based on the use purpose of the mechanical equipment will be referred to as a normal state, and an operation status out of the allowable range will be referred to as a malfunction state or an abnormal state. For example, in the case where a manufacturing machine is in the malfunction state or the abnormal state, a malfunction such as manufacture of a defected product or stoppage of a manufacturing line occurs.

In the case of a manufacturing machine or the like, generally a maintenance operation is performed regularly or irregularly even if the same operation is repeatedly and continuously performed to suppress the occurrence of the malfunction state as much as possible. Although it is effective to shorten an execution interval between maintenance operations for increasing the preventive safety, since the manufacturing machine or the like is stopped during the maintenance operation, the operation rate of the manufacturing machine or the like is decreased if the frequency of the maintenance operation is excessively increased. Therefore, when occurrence of the malfunction state is near while the machine or the like is still in the normal state, it is desirable that this state can be detected. This is because, in this case, the maintenance operation of the machine or the like may be performed when the approach of the malfunction state is detected, that is, when the occurrence of the malfunction is predicted, and therefore excessive decrease of the operation rate can be suppressed.

As a method for predicting the occurrence of malfunction, a method of preparing a post-learning model generated by machine learning of the state of the mechanical equipment in advance and evaluating the state of the mechanical equipment at the time of the evaluation by using the post-learning model is known. For example, a method of generating a post-learning model by machine learning of characteristics of the normal state of the mechanical equipment, calculating a deviation degree between the state of the mechanical equipment at the time of evaluation and the normal state learned by the machine learning, and predicting the occurrence of malfunction on the basis of the calculated deviation degree is known. To increase the prediction accuracy, it is important to construct a post-learning model suitable for prediction of malfunction. However, for this, whether or not learning data used for the machine learning is appropriate is important.

For example, Japanese Patent Laid-Open No. 2011-70635 discloses extracting a vector on the basis of a sensor signal indicating the state of mechanical equipment and selecting a feature to be used on the basis of data check of a feature vector. Further, Japanese Patent Laid-Open No. 2011-70635 discloses generating a model of a normal state of the mechanical equipment on the basis of selected learning data.

In addition, regarding selection from a plurality of pieces of learning data prepared for respective seasons in accordance with seasonal change, Japanese Patent Laid-Open No. 2011-59790 discloses selecting a sensor signal that should be focused on and selected in accordance with abnormality, on the basis of an abnormality measure, which is a result of multivariate analysis, and an evaluation result of a degree of influence of each sensor signal.

In mechanical equipment, measurement data is obtained for various parameters to manage the operation status of the mechanical equipment. In the case of generating data for machine learning to generate a model of the normal state of the mechanical equipment, it is important to appropriately extract the measurement data obtained while the mechanical equipment is operating in the normal state.

However, in the case of, for example, mechanical equipment installed in a manufacturing line such as an industrial robot, it is difficult to appropriately extract the data obtained while the mechanical equipment is operating in the normal state.

A robot installed in a manufacturing line generally repeatedly performs the same operation for repeatedly producing the same product, but even if the robot itself is in the normal state, the operation can be affected by the state of machines in charge of steps before and after a step performed by the robot. For example, a case where the robot receives a workpiece from the machine in charge of the previous step, performs an operation of a step that the robot is in charge of, for example, assembly of parts, and passes the workpiece onto a machine in charge of the next step is assumed. Even if the robot is in the normal state, in the case where the cycle time of the robot is shorter than the cycle time of the machine in charge of the previous step, there is a time when the robot is on standby, which means that the robot is not operating all the time. Similarly, in the case where the cycle time of the robot is shorter than the cycle time of the machine in charge of the next step, there is a time when the robot is on standby, which means that the robot is not operating all the time.

In addition, even if the cycle times of the previous and next steps are set to be equal to the cycle time of the operation of the robot, in the case where abnormality occurs in the previous or next step, a situation in which there is a trouble in the passing of the workpiece, and the robot has to be stopped even though the robot itself is in the normal state can occur. This is because, for example, the robot has to wait for the workpiece to be delivered from the machine in charge of the previous step or has to stop the operation until it becomes possible for the machine in charge of the next step to receive the workpiece.

As described above, even if the robot is in the normal state, continuous measurement data includes measurement data obtained when the robot is on standby or the robot is stopped, and the measurement data includes data that serves as noise when used as learning data for machine learning of the characteristics of the robot while the robot is operating in the normal state.

Further, various measurement data obtained when a processing operation is repeatedly performed also includes measurement data not indicating the characteristics of the robot while the robot is operating in the normal state in addition to the data serving as noise obtained when the robot is on standby or stopped. For example, in the case where the robot operates under six-axis control, the six axes include an axis in which the robot operates frequently, an axis in which the robot does not operate frequently, and an axis in which the robot does not operate at all, depending on the programmed processing operation. Therefor, data obtained by measuring the driving state in each axis includes measurement data not reflecting the characteristics of the robot while the robot is operating in the normal state. Therefore, in the case of all of various measurement data is used, the measurement data is redundant or includes noise as learning data for machine learning of the characteristics of the robot while the robot is operating in the normal state.

In Japanese Patent Laid-Open No. 2011-70635 and Japanese Patent Laid-Open No. 2011-59790, although selecting learning data is recognized, there is no sufficient discussion on a specific method for selecting and obtaining learning data in mechanical equipment such as a manufacturing machine that repeatedly performs operation. Therefore, it is difficult to generate a post-learning model of high prediction accuracy by a conventional method.

Therefore, regarding mechanical equipment which repeatedly performs the same operation but changes how to operate depending on the situation of the previous and next steps such as a robot installed in a manufacturing line, a method for appropriately extracting learning data for machine learning of the characteristics of the mechanical equipment while the mechanical equipment is operating in the normal state has been desired.

### SUMMARY

According to a first aspect of the present disclosure, a control method includes obtaining, in a first period, a measurement value related to mechanical equipment in a first state, specifying a period in which the mechanical equipment is in an operating state in the first period, by using the measurement value and profile information of the measurement value corresponding to a time when the mechanical equipment is in the operating state, and extracting, as data for machine learning, a feature value based on the measurement value corresponding to the specified period which is in the first period and in which the mechanical equipment is in the operating state.

According to a second aspect of the present disclosure, a control apparatus includes a controller configured to obtain, in a first period, a measurement value related to mechanical equipment in a first state, specify a period in which the mechanical equipment is in an operating state in the first period, by using the measurement value and profile information of the measurement value corresponding to a time when the mechanical equipment is in the operating state, and extract, as data for machine learning, a feature value based on the measurement value corresponding to the specified period which is in the first period and in which the mechanical equipment is in the operating state.

Further features of the present disclosure will become apparent from the following description of exemplary embodiments with reference to the attached drawings.

### BRIEF DESCRIPTION OF THE DRAWINGS

FIG. 1 is a schematic function block diagram for describing functional blocks included in a malfunction prediction system of an embodiment.

FIG. 2 is a schematic diagram for describing a hardware configuration of the embodiment.

FIG. 3 is a schematic diagram for describing a method for extracting feature values according to one or more aspects of the present disclosure.

FIG. 4A illustrates an example of measurement data of one cycle of operation.

FIG. 4B illustrates an example of unit recording data serving as a unit record and corresponding to a case of continuous operation.

FIG. 4C illustrates an example of the unit recording data serving as a unit record and including a period of a non-operating state.

FIG. 5A is a diagram for describing an operation profile.

FIG. 5B is a diagram illustrating a case determined as operating.

FIG. 5C illustrates an example of a case determined as including a non-operating state.

FIG. 6 is a schematic diagram for describing a machine learning method according to one or more aspects of the present disclosure.

FIG. 7 is a schematic diagram for describing a method for determining a determination threshold value according to one or more aspects of the present disclosure.

FIG. 8 is a schematic diagram for describing a malfunction prediction method according to one or more aspects of the present disclosure.

FIG. 9 is a flowchart illustrating a processing procedure for generation of a malfunction prediction model according to one or more aspects of the present disclosure.

FIG. 10 is a flowchart illustrating a processing procedure of malfunction prediction according to one or more aspects of the present disclosure.

FIG. 11 is a perspective view of a six-axis robot serving as an example of mechanical equipment.

FIG. 12 is a diagram illustrating operation of each rotary joint of the six-axis robot.

FIG. 13 is a schematic diagram for describing a method for determining an operation profile according to one or more aspects of the present disclosure.

### DESCRIPTION OF THE EMBODIMENTS

As an embodiment of the present disclosure, a malfunction prediction system, a control method, a control apparatus, mechanical equipment including the control apparatus, a control program, a computer-readable recording medium, and the like that are used for predicting malfunction of mechanical equipment will be described with reference to drawings.

### Configuration of Functional Block

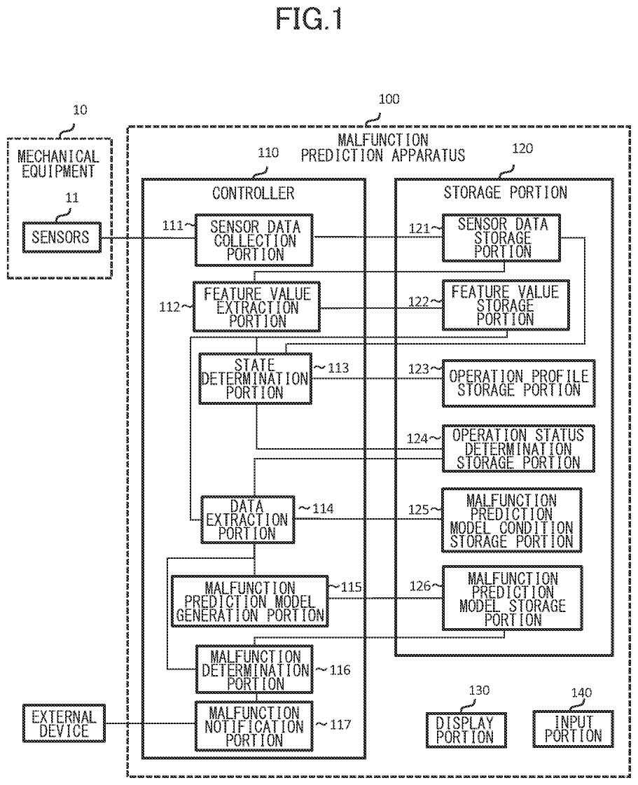

FIG. 1 is a schematic functional block diagram for describing a configuration of functional blocks included in a malfunction prediction system of the embodiment. To be noted, although functional elements required for describing a feature of the present embodiment are indicated as functional blocks in FIG. 1, illustration of general functional elements not directly related to the problem-solving principle of the present disclosure is omitted. In addition, each functional element illustrated in FIG. 1 is functionally conceptual, and is not necessarily physically configured as illustrated. For example, a specific configuration concerning distribution and integration of each functional block is not limited to the illustrated example, and all or part thereof can be functionally or physically distributed or integrated by arbitrary unit in accordance with the use condition or the like.

As illustrated in FIG. 1, the malfunction prediction system of the embodiment includes mechanical equipment 10, which is a target of diagnosis, and a malfunction prediction apparatus 100.

The mechanical equipment 10 can be various industrial devices that manufacture a product as a resultant article by assembling workpieces, such as an articulated robot and a manufacturing apparatus installed in a manufacturing line. The mechanical equipment 10 includes various sensors 11 for measuring the state of the mechanical equipment 10. For example, in the case where the mechanical equipment 10 is an articulated robot, a sensor for measuring a current value of a motor driving a joint, an angle sensor of a joint, a sensor for measuring a speed, vibration, or sound, and the like can be provided. However, these are mere examples, and sensors of appropriate kinds and numbers can be provided as the sensors 11 at appropriate positions depending on the kind, use purpose, and the like of the mechanical equipment 10. As the sensors 11, various sensors such as a force sensor, a torque sensor, a vibration sensor, a sound sensor, an image sensor, a distance sensor, a temperature sensor, a humidity sensor, a flow rate sensor, a pH sensor, a pressure sensor, a viscosity sensor, and a gas sensor can be used. To be noted, although only a single sensor 11 is illustrated in FIG. 1 for the sake of convenience of illustration, normally a plurality of sensors are provided.

The mechanical equipment 10 is communicably connected to the malfunction prediction apparatus 100 in a wired or wireless manner, and the malfunction prediction apparatus 100 can obtain data measured by the sensors 11 through communication.

In the stage of generating a malfunction prediction model, the malfunction prediction apparatus 100 selects a feature value highly correlated with occurrence of malfunction of the mechanical equipment 10 by using data collected from the sensors 11, and generates and stores a post-learning model, that is, a malfunction prediction model, by machine learning using the selected feature value. In addition, in an evaluation stage, that is, a malfunction prediction stage, data at the time of evaluation collected from the sensors 11 is input to the post-learning model, a deviation degree is calculated by using an input and an output of the post-learning model, and it is determined whether occurrence of malfunction is near. Hereinafter, functional blocks included in the malfunction prediction apparatus 100 will be sequentially described.

The malfunction prediction apparatus 100 includes a controller 110, a storage portion 120, a display portion 130, and an input portion 140.

The controller 110 includes a plurality of functional blocks, and these functional blocks are constituted by, for example, a central processing unit: CPU of the malfunction prediction apparatus 100 reading and executing a control program stored in a storage device. Alternatively, part or all of the functional blocks may be constituted by hardware included in the malfunction prediction apparatus 100, such as an application specific integrated circuit: ASIC.

The storage portion 120 includes a sensor data storage portion 121, a feature value storage portion 122, an operation profile storage portion 123, an operation status determination storage portion 124, a malfunction prediction model condition storage portion 125, and a malfunction prediction model storage portion 126. Each of these portions included in the storage portion 120 are configured by being appropriately assigned to storage regions of a storage device such as a hard disk drive, a random access memory: RAM, or a read-only memory: ROM. The storage portion 120 is a data obtaining portion that obtains and stores various data required for processing for execution of malfunction prediction.

The display portion 130 and the input portion 140 are user interfaces included in the malfunction prediction apparatus 100. A display device such as a liquid crystal display or an organic electroluminescence display is used as the display portion 130, and an input device such as a keyboard, a jog dial, a mouse, a pointing device, or a sound input device is used as the input portion 140.

A sensor data collection portion 111 of the controller 110 obtains measurement data from the sensors 11 of the mechanical equipment 10 and stores the measurement data in the sensor data storage portion 121. That is, for example, measurement data concerning the state of the mechanical equipment 10 such as a current, speed, pressure, vibration, sound, temperature of each part, and the like measured in the mechanical equipment 10 is collected and stored in the sensor data storage portion 121.

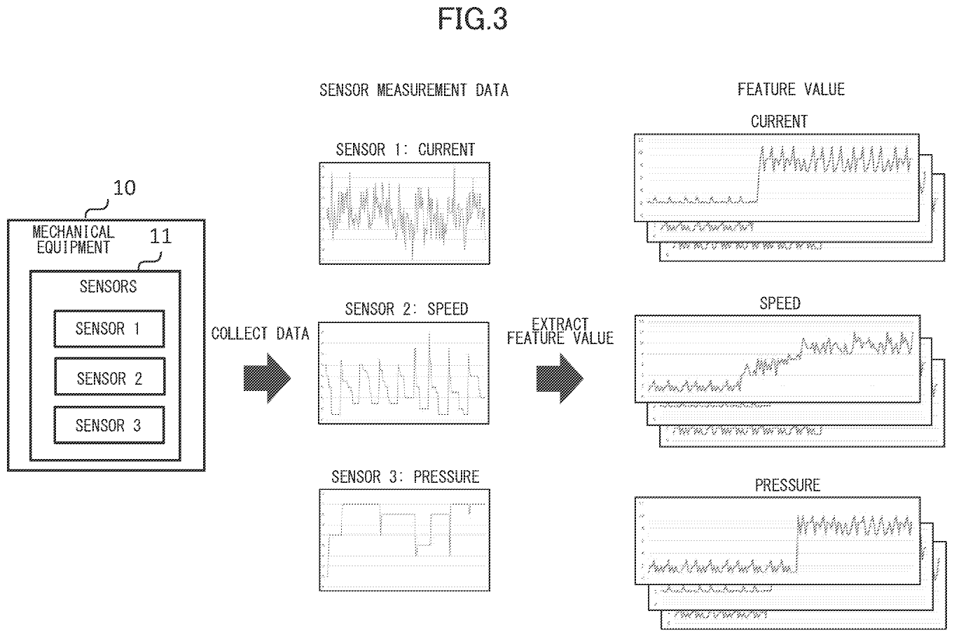

A feature value extraction portion 112 extracts a feature value indicating characteristics of the state of the mechanical equipment 10 on the basis of the measurement data stored in the sensor data storage portion 121, and stores the feature value in the feature value storage portion 122. For example, as feature value data, the maximum values and/or minimum values of measurement values of the sensors 11 collected in one operation cycle of the mechanical equipment 10 may be extracted, or average values of the measurement values may be calculated. Alternatively, measurement values of sensors in a predetermined period may be converted into a time-series frequency region by integration. In addition, differential values or secondary differential values of measurement values arranged in time-series with respect to time may be used as the feature value data. In addition, in the case where the measurement values themselves of the sensors 11, that is, the raw data of the measurement values, are useful as determinants for detecting whether or not occurrence of malfunction is near, the measurement values themselves may be used as the feature value data. In the present embodiment, the feature value extraction portion 112 extracts or calculates a feature value on the basis of the measurement value of the sensors 11, and generates and stores time-series feature value data in the feature value storage portion 122. To be noted, extraction of the feature value will be described in detail later with reference to FIG. 3.

A state determination portion 113 obtains the sensor data from the sensor data storage portion 121, the feature value from the feature value storage portion 122, and definition of an operation profile for determining the operation status (running status) from the operation profile storage portion 123. The definition of the operation profile is information regarding a determination criterion for determining whether or not the mechanical equipment 10 is operating or stopped, that is, whether the mechanical equipment 10 is in an operating state or in a non-operating state. The state determination portion 113 specifies, on the basis of the obtained information, a period in which the mechanical equipment 10 was operating, and then stores the information related to the period determined as a period in which the mechanical equipment 10 was operating in the operation status determination storage portion 124. To be noted, the state determination portion 113 does not have to obtain both of the sensor data and the feature value, and, for example, if the operation status of the mechanical equipment 10 can be determined by using only the sensor data, the state determination portion 113 may obtain only the sensor data.

When generating a post-learning model, a data extraction portion 114 extracts the feature value from the feature value storage portion 122 on the basis of the information related to the period in which the mechanical equipment 10 was operating stored in the operation status determination storage portion 124 and information stored in the malfunction prediction model condition storage portion 125. The extracted feature value is output to a malfunction prediction model generation portion 115 as data for machine learning. The malfunction prediction model condition storage portion 125 stores, in advance, information that specifies a feature value indicating the characteristics of the mechanical equipment 10 in a normal state among various feature values. Therefore, a feature value indicating the characteristics of the mechanical equipment 10 in the normal state is selected, and also only a part of the feature value corresponding to the period in which the mechanical equipment 10 was operating is extracted.

In addition, at the time of evaluation, the data extraction portion 114 extracts the feature value from the feature value storage portion 122 on the basis of the operating period of the mechanical equipment 10 stored in the operation status determination storage portion 124 and the information stored in the malfunction prediction model condition storage portion 125. The extracted feature value is output to a malfunction determination portion 116 as feature value data for evaluation. Therefore, a feature value of the same kind as that used for machine learning is selected as the feature value data for evaluation, and also only a part of the feature value corresponding to the period in which the mechanical equipment was operating is extracted.

When generating a post-learning model, the malfunction prediction model generation portion 115 generates a post-learning model, that is, a malfunction prediction model by using the data for machine learning input from the data extraction portion 114, and stores the post-learning model in the malfunction prediction model storage portion 126.

At the time of evaluation, a malfunction determination portion 116 inputs the feature value data for evaluation input from the data extraction portion 114 to the post-learning model, that is, a malfunction prediction model stored in the malfunction prediction model storage portion 126, and calculates a deviation degree between the input and output thereof. Then, the malfunction determination portion 116 determines whether or not there is a sign of malfunction by comparing the deviation degree with a determination threshold value.

A malfunction notification portion 117 notifies a determination result of the malfunction determination portion 116 to an external device or displays the determination result on the display portion 130.

### Hardware Configuration

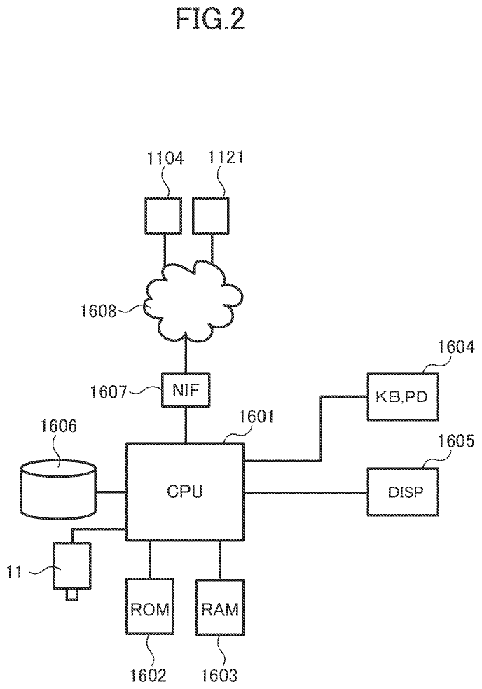

FIG. 2 schematically illustrates an example of a hardware configuration of the malfunction prediction system of the embodiment. The malfunction prediction system can include a personal computer hardware including a CPU 1601 as a main controller, and a ROM 1602 and a RAM 1603 as storage portions as illustrated in FIG. 2. The ROM 1602 can store information such as a processing program and an inference algorithm for realizing a malfunction prediction method that will be described later. In addition, the RAM 1603 is used as a work area or the like for the CPU 1601 when executing the control procedure of the method. In addition, an external storage device 1606 is connected to a control system of the malfunction prediction system. The external storage device 1606 is constituted by a hard disk drive: HDD, a solid state device: SSD, an external storage portion of another system that is mounted thereon via a network, or the like.

The control program for the CPU 1601 to realize the malfunction prediction method of the present embodiment that will be described later can be stored in a storage portion such as the external storage device 1606 constituted by an HDD or an SSD, or, for example, an electrically erasable programmable ROM region: EEPROM region of the ROM 1602. In this case, the processing program for the CPU 1601 to realize the malfunction prediction method is supplied to each storage portion described above through a network interface: NIF 1607, and can be updated to a new program, that is, a different program. Alternatively, the processing program for the CPU 1601 to realize the malfunction prediction method can be supplied to each storage portion described above via various storage media such as magnetic disks, optical disks, and flash memories and drive devices therefor, and the contents thereof can be updated. The various storage media, storage portions, or storage devices that store a program with which the CPU 1601 can execute a process for realizing the malfunction prediction method constitute computer-readable recording media storing a malfunction prediction procedure of the present disclosure.

The CPU 1601 is connected to the sensors 11 illustrated in FIG. 1. Although the sensors 11 are illustrated as being directly connected to the CPU 1601 for simpler illustration in FIG. 2, the sensors 11 may be connected to the CPU 1601 via, for example, an IEEE 488, that is, a so-called general purpose interface bus: GPIB. In addition, the sensors 11 may be connected to the CPU 1601 via a network interface 1607 and a network 1608.

The network interface 1607 can be constitute by, for example, using a communication standard of wired communication such as IEEE 802.3, or a communication standard of wireless communication such as IEEE 802.11 or 802.15. The CPU 1601 can communicate with other apparatuses 1104 and 1121 via the network interface 1607. For example, in the case where the mechanical equipment serving as a target of malfunction prediction is a robot, the apparatuses 1104 and 1121 may be an integral control apparatus such as a programmable logic control: PLC or a sequencer, a management server, or the like that is disposed for controlling or managing the robot.

In the example illustrated in FIG. 2, an operation portion 1604 and a display apparatus 1605 related to the input portion 140 and the display portion 130 illustrated in FIG. 1 are connected to the CPU 1601 as user interface devices: UI devices. The operation portion 1604 can be constituted by a terminal such as a handy terminal, a device such as a key board, a jog dial, a mouse, a pointing device, a sound input device, or a control terminal including these. The display apparatus 1605 may be any device as long as information related to processing performed by the state determination portion 113, the malfunction prediction model generation portion 115, the malfunction determination portion 116, and the like can be displayed on a display screen thereof and for example, a liquid crystal display apparatus can be used.

### Malfunction Prediction Method

In the present embodiment, the malfunction prediction model generation portion 115 of the malfunction prediction apparatus 100 constructs a post-learning model serving as a malfunction prediction model by so-called unsupervised learning. To learn characteristics of malfunction of mechanical equipment by unsupervised learning, machine learning is performed by using only operation data of a state without malfunction, that is, operation data of a period in which the mechanical equipment is operating normally. In unsupervised learning, the distribution of input data is learned by providing only a large amount of input data to a learning apparatus. That is, unsupervised learning is a method of causing an apparatus that performs processing such as compression, classification, and deformation on input data to learn processing without providing the apparatus with teacher output data corresponding to the input data.

A malfunction prediction method using the method of unsupervised learning will be described in detail. Machine learning is performed by setting a case where the operation status is within an allowable range as a normal state in consideration the use purpose of the mechanical equipment and using only the operation data of the mechanical equipment in the normal state. In the present embodiment, an auto encoder is used as an unsupervised learning model.

The present embodiment is characterized by a method of extracting the data used for machine learning. That is, the present embodiment is characterized in that a feature value indicating a behavior corresponding to a case where the mechanical equipment is in the normal state is selected, and only data of a period in which the mechanical equipment was operating is extracted from continuous data of the selected feature value and used as learning data.

First, extraction of the feature value will be described with reference to FIG. 3. It is assumed that the sensors 11 included in the mechanical equipment 10 serving as a target of malfunction prediction include a sensor 1 that is a current sensor, a sensor 2 that is a speed sensor, and a sensor 3 that is a pressure sensor, as illustrated in FIG. 3 as an example. In the malfunction prediction method according to the present embodiment, first, a feature value indicating the operation status of the mechanical equipment 10 is extracted on the basis of measurement data of each sensor included in the sensors 11. The feature value is extracted by performing integral transform of time-series measurement data of the sensors 11 into a frequency region, calculating primary differential or secondary differential of the measurement data with respect to time, performing filtering processing on the measurement data, extracting a maximum value and a minimum value of a periodic operation from the measurement data, or the like. To be noted, the sensors and processing of measurement data described above are mere examples, and any sensors and processing of measurement data may be employed as long as data suitable for grasping the state of the mechanical equipment can be obtained. In addition, if the state of the mechanical equipment can be easily analyzed by using the measurement data itself of the sensors, the measurement data itself may be used as the feature value without performing any special processing.

FIG. 3 schematically illustrates a state in which time-series data of feature values of 9 kinds illustrated on the right side are extracted by performing 3 kinds of processing on each of measurement data of the sensors 1 to 3.

Next, a method of determining whether the mechanical equipment 10 is operating or stopped, that is, whether the mechanical equipment 10 is in the operating state or the non-operating state, and specifying the period in which the mechanical equipment 10 was operating will be described.

Here, an articulated robot that is installed in a manufacturing line and is in charge of a step in a manufacturing process is mentioned as an example of the mechanical equipment 10. The articulated robot receives a workpiece from a machine in charge of a previous step, performs an operation of the step that the articulated robot is in charge of, for example, assembly of parts, and passes the workpiece onto a machine in charge of the next step, and the same operation is repeatedly performed for repeatedly manufacturing the same product.

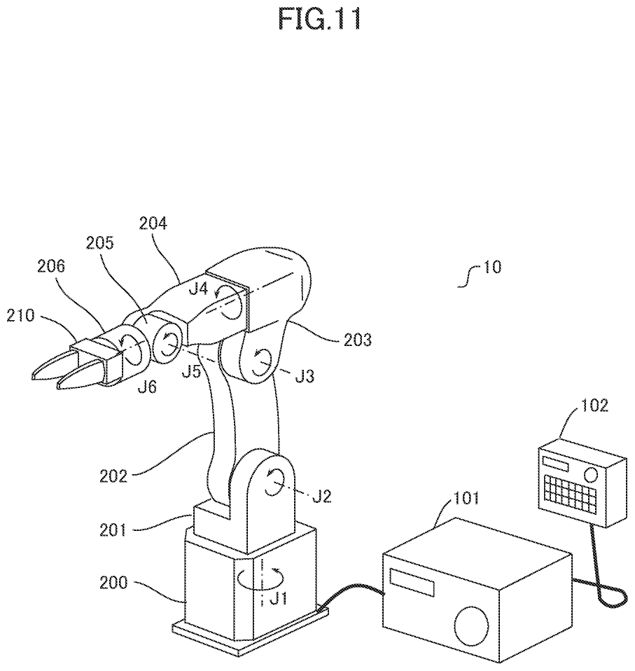

FIG. 11 illustrates an external appearance of a six-axis articulated robot serving as an example of the mechanical equipment 10.

Links 200 to 206 are serially interconnected by six rotary joints J1 to J6. Each rotary joint includes a sensor that measures the rotation speed of a motor, a sensor that measures the rotation angle of the joint, a torque sensor, and so forth. A robot hand 210 can be attached to a link on the distal end. A teaching pendant 102 is connected to the control apparatus 101 that controls the operation of the robot, and an operator can teach an operation thereby.

A robot installed in a manufacturing line repeatedly performs a cycle operation, that is, a predetermined operation, and in the case of a six-axis articulated robot, the six axes can include an axis in which the robot frequently operates and an axis in which the robot does not operate at all, depending on the cycle operation. For example, in a step in which a workpiece is rotated at a fixed position, only the joint J6, which is a rotary joint at a distal end portion, may be operated, and the other rotary joints J1 to J5 do not operate. In contrast, in a step of, for example, moving the workpiece horizontally, mainly the rotary joint J1 operates, and the rotary joints J5 and J6 close to the distal end may not operate.

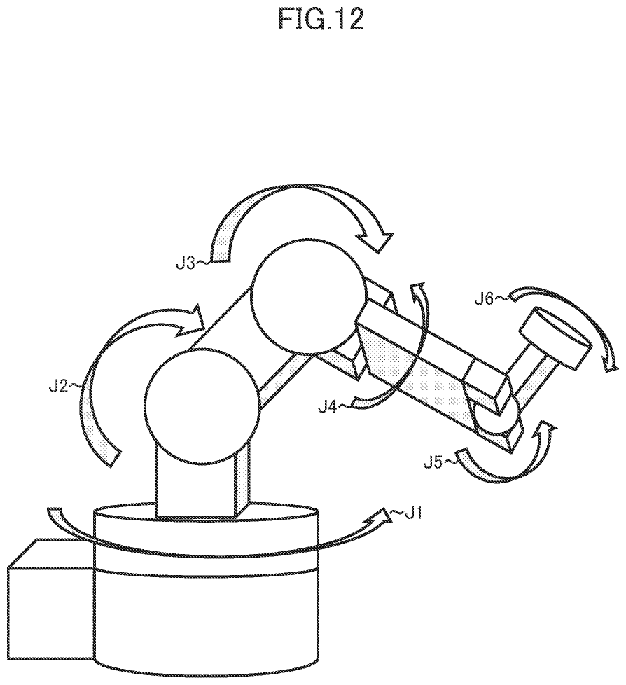

FIG. 12 illustrates the operation direction of each rotary joint of the six-axis articulated robot, and whether or not each rotary joint is driven can be recognized by, for example, measuring the rotation speed of the motor that drives the rotary joint. However, since the operation of each rotation axis changes depending on the cycle operation as described above, the rotation speed of a rotary joint that is driven most frequently in the cycle operation performed by the robot may be measured for determining whether or not the robot is operating.

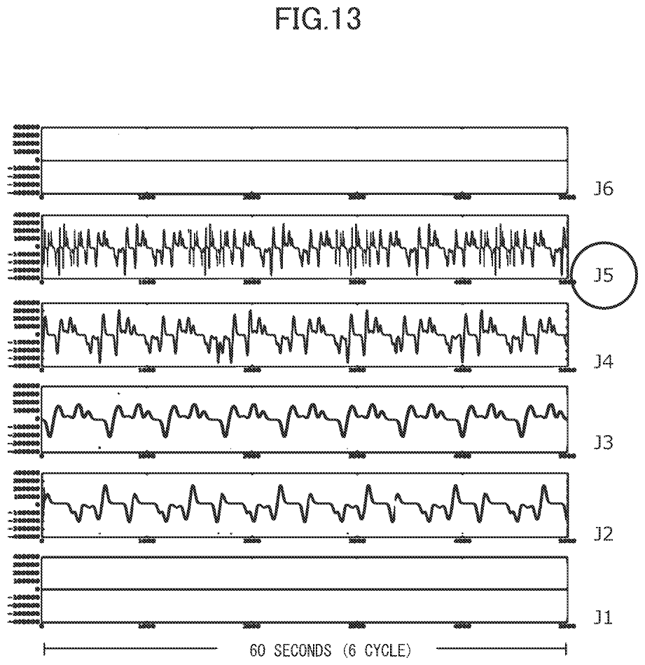

Here, a method for selecting the rotary joint that is driven most frequently while the robot is performing the cycle operation will be described. FIG. 13 illustrates measurement results of rotation speed sensors of the rotary joints J1 to J6 in the case where the robot is stably and continuously performing a certain cycle operation, for example, an assembly operation. The length of one cycle of the cycle operation is set to 10 seconds, and sensor output waveforms of 6 cycles each are illustrated. As illustrated, it can be seen that in this cycle operation, for example, assembly operation, the rotary joint J5 is driven the most frequently over the entire period, and conversely the rotary joints J1 and J6 are not driven. Therefore, it can be said that monitoring the rotation speed of the rotary joint J5 is the most suitable for determining whether or not the robot that executes this cycle operation is operating.

To automatically select the rotary joint that operates the most frequently, the malfunction prediction apparatus 100 obtains, from the sensors 11, the rotation speed data of each rotary joint that is stably operating, and measures the number of times the rotation speed becomes zero, that is, the number of times the graph intersects with the line of zero. The controller 110 compares the number of times the rotation speed becomes zero between the rotary joints, and determines the rotary joint of the largest number of times of the rotation speed becoming zero, which is the rotary joint J5 in the example of FIG. 13, as a rotary joint to be used for an operation profile. This is because if the number of times the rotation speed becomes zero is the largest, the number of times the speed is switched is also the largest, and therefore the rotary joint is suitable for determining whether the robot is operating. That is, profile information that will be described later is set on the basis of a measurement value whose degree of change in the case where the mechanical equipment performs a predetermined repetitive operation is large among measurement values obtained by a plurality of sensors.

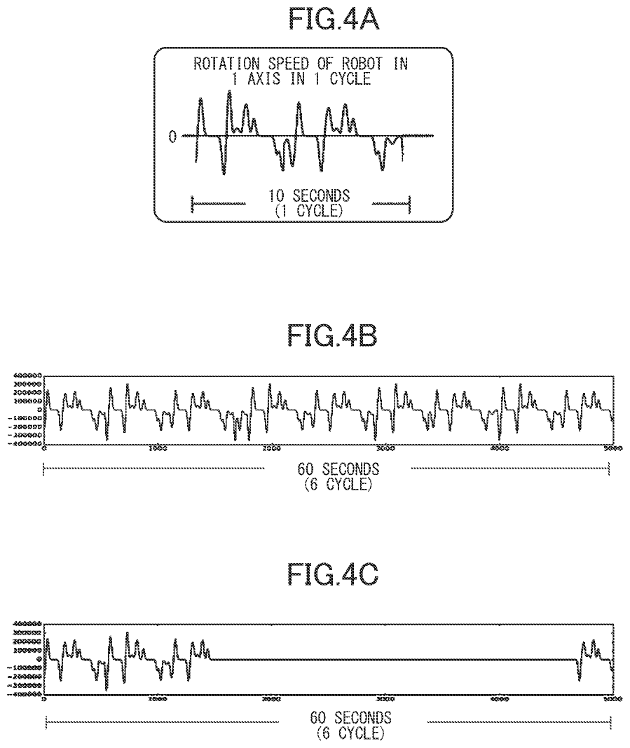

FIG. 4A illustrates an example of measurement data of rotation speed of the motor driving the rotary joint J5 determined as described above as a waveform of a period in which the robot performs the one step the robot is in charge of, that is, the operation of one cycle. Here, a case where one cycle operation is performed in 10 seconds is described as an example.

Incidentally, the sensor data collection portion 111 collects measurement data output from the sensors 11 in time series and stores the collected measurement data in the sensor data storage portion 121. In this case, for the sake of convenience of handling, temporally continuous measurement data is divided by a predetermined time, for example, 60 seconds, and measurement data corresponding to the predetermined time is handled as one piece of unit recording data serving as a unit record. A period corresponding to each piece of unit recording data, that is, a unit record, will be referred to as a unit recording period.

FIG. 4B is a graph illustrating unit recording data, that is, a unit record, in the case where the robot in the normal state is continuously operating as an example. Meanwhile, as has been described, a robot installed in a manufacturing line may temporarily stop operating, that is, may temporarily take the non-operating state, depending on the state of machines in charge of the previous and next steps. In this case, the unit recording data, that is, the unit record includes measurement data of the non-operating state as illustrated in FIG. 4C.

In the unit recording period illustrated in FIG. 4B as an example, since the robot is continuously operating, there is no problem in using a feature value corresponding to this unit recording period as learning data. However, since the unit recording period illustrated in FIG. 4C as an example includes a period in which the robot is in the non-operating state even if the robot is in the normal state, the feature value corresponding to this unit recording period includes noise as the learning data.

Therefore, in the present embodiment, the state determination portion 113 checks, for the unit recording period corresponding to each piece of unit recording data, that is, each unit record stored in the sensor data storage portion 121, whether or not the mechanical equipment, that is, the robot, has taken the non-operating state.

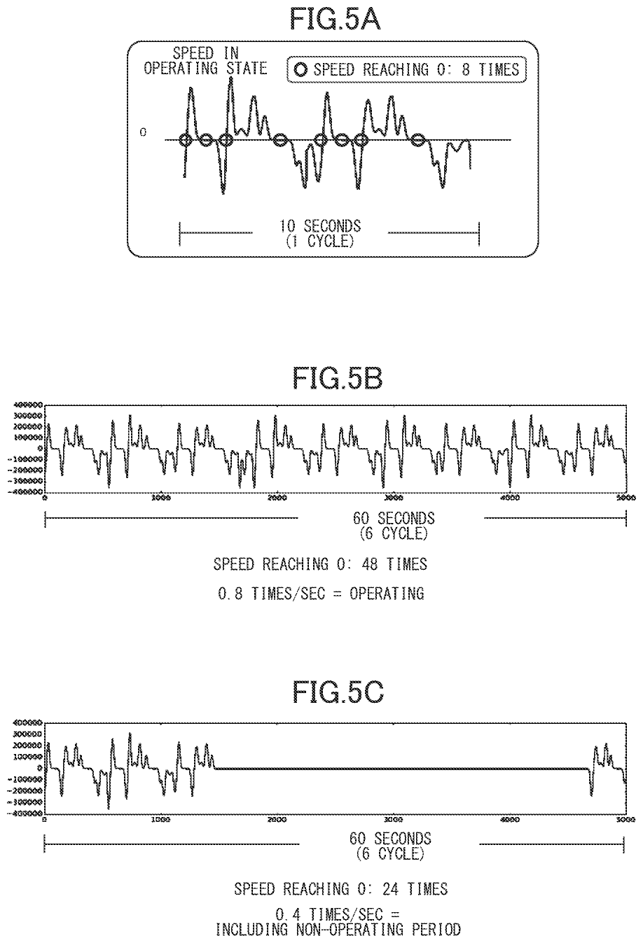

Specifically, profile information related to a feature of one cycle of operation that is repeatedly performed is stored in the operation profile storage portion 123 in advance. In this case, the speed of the motor that repeats acceleration and deceleration has a feature of reaching 0 eight times during one cycle whose length is 10 seconds as illustrated in FIG. 5A, and therefore the number of times the speed reaches 0 being 0.8 times/sec is stored in advance as profile information indicating the operation status. That is, the profile information is set on the basis of the number of times the measurement value of the speed sensor reaches 0 in a unit time.

The state determination portion 113 obtains the profile information indicating the operation status, that is, information indicating that the number of times the speed reaches 0 is 0.8 times/sec, from the operation profile storage portion 123. Then, the state determination portion 113 determines, for each piece of unit recording data, that is, each unit record, of the motor speed stored in the sensor data storage portion 121, whether or not the unit recording data corresponds to the operating state, that is, whether or not the unit recording data includes the non-operating state.

For example, as illustrated in FIG. 5B, in the case where the robot continuously has operated without stopping, the number of times the speed has reached 0 in unit recording data, that is, a unit record of 60 seconds is counted as 48, which is calculated as 0.8 times/sec. Since this value matches the profile, it is determined that the robot was operating.

In contrast, for example, in the case where the unit recording data, that is, the unit record includes a period in which the robot was stopped as illustrated in FIG. 5C, the counted number of times the speed reaches 0 is only 24, which is calculated as 0.4 times/sec. Since this value does not match the profile, it is determined that the robot includes a non-operating period.

To be noted, the profile for determining that the robot is “operating” does not have to beset to a fixed value, which is 0.8 times/sec in this case. This value may be set to a range of a certain width, for example, 0.8 times/sec±20%, in consideration of the fluctuation of the robot operation speed in the manufacturing line, that is, the fluctuation of a tact time, or the like. Alternatively, for example, 0.7 times/sec may be set as a threshold value such that data of a value equal to or greater than 0.7 times/sec is determined as “operating” and data of a value less than 0.7 times/sec is determined as “including a non-operating period”.

As described above, whether the robot was “operating” in a unit recording period corresponding to each piece of unit recording data, that is, a unit record, or the unit recording period includes a “non-operating period” is determined. In this manner, the state determination portion 113 specifies a unit recording time in which the robot was in the operating state, and stores this information in the operation status determination storage portion 124. For example, in information of a timeline serving as calendar information, a unit recording period determined as corresponding to the operating state is labeled as “operating”, a unit recording period including the non-operating period is labeled as “noise”, and this information is stored in the operation status determination storage portion 124.

When performing machine learning, the data extraction portion 114 reads out information of the unit recording period labeled as “operating” from the operation status determination storage portion 124, and extracts a feature value corresponding to this unit recording period from the feature value storage portion 122. The data extraction portion 114 outputs the extracted feature value as learning data to the malfunction prediction model generation portion 115.

As described above, according to the present embodiment, only feature value data corresponding to the unit recording period in which the robot was operating is selectively extracted from time-series feature value data, and thus data for machine learning with less noise can be generated.

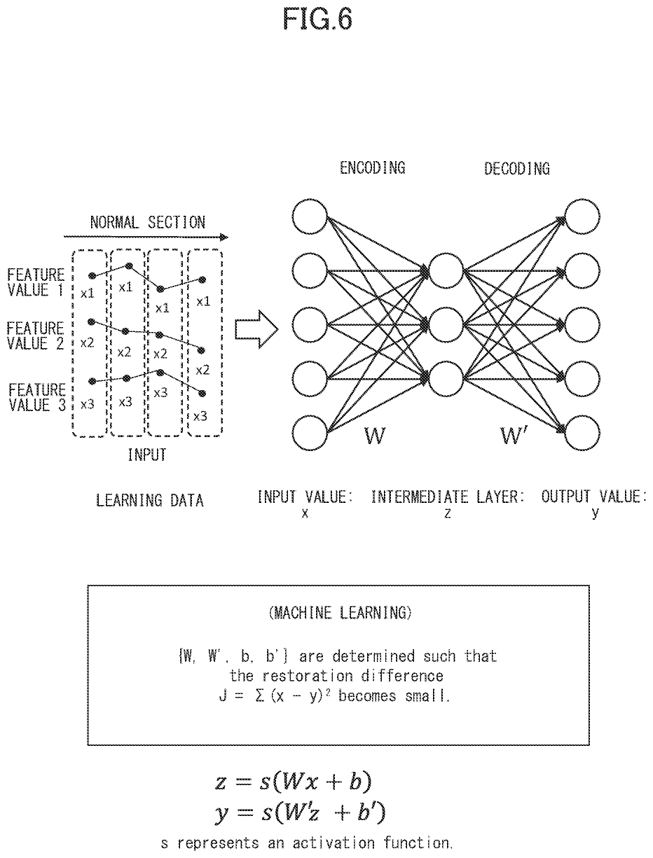

Next, a method of causing an auto encoder to perform machine learning by using the learning data extracted as described above will be described with reference to FIG. 6, which is a schematic diagram. The auto encoder is a kind of neural network that compresses, that is, encodes the input learning data into data of a smaller data size and then restores, that is, decodes the data. The auto encoder learns “a parameter for appropriately compressing and restores the input data”, that is, characteristics of the input data.

The auto encoder encodes an input value x to compress the input value x into an intermediate layer z. Then, the auto encoder decodes the intermediate layer z to restore the intermediate layer z as an output value y. The auto encoder performs machine learning such that a restoration difference J between the input value and the output value becomes smaller.

That is, the auto encoder determines W and b of Formula 1 below and W′ and b′ of Formula 2 below such that the restoration difference J in Formula 3 below becomes smaller. To be noted, s represents an activation function.

z=s(Wx+b) Formula 1

y=s(W′z+b′) Formula 2

RESTORATION DIFFERENCE J=Σ(x−y)² Formula 3

When data having characteristics similar to those of the learning data is input, the auto encoder that has performed learning outputs an output value with a small restoration difference by encoding and decoding using a parameter obtained by the learning. The auto encoder that has performed learning will be sometimes described as a post-learning model or a malfunction prediction model. In contrast, when data having characteristics different from the learning data is input to the post-learning model, the encoding and decoding cannot be performed successfully by using the parameter obtained by the learning, and therefore the restoration difference is large.

To utilize this nature for prediction of a malfunction state, that is, an abnormal state, in the present embodiment, the auto encoder is caused to perform machine learning by using a feature value corresponding to a period in which the robot was in the normal state and was operating as the input value x.

In addition, when performing malfunction prediction, a feature value that is of the same kind as a feature value selected during learning and corresponds to the period in which the robot was operating is extracted from feature values extracted at the time of evaluation, and the extracted feature value is input as the input value x to the post-learning model to output the output value y. Then, the restoration difference between the input value x and the output value y is calculated, and the restoration difference, that is, the deviation degree between the input and output is used as an indicator indicating the degree of deviation of the mechanical equipment from the normal state.

In addition, in the present embodiment, a determination threshold value used for determining whether or not the occurrence of malfunction of the mechanical equipment is near by using the deviation degree is set in advance. To set the determination threshold value, first a feature value based on the sensor data of the actual mechanical equipment corresponding to a period in which the occurrence of malfunction is reached from the normal state is extracted and input, and the temporal change of the deviation degree until the occurrence of malfunction is studied.

In the present embodiment, as the feature value data used in this case, an extracted feature value that is of the same kind as a feature value selected during learning, that is a feature value obtained by performing the same processing on measurement data of the same sensor, and corresponds to a period in which the robot was operating is used. The period in which the robot was operating is specified by determination using the operation profile similarly to the case described for generation of the learning data. The determination threshold value for determining that the occurrence of malfunction is near is set on the basis of the temporal change of the deviation degree. In the case where the deviation degree is equal to or greater than the determination threshold value, it is determined that the occurrence of malfunction of the mechanical equipment is near, that is, there is a sign of malfunction.

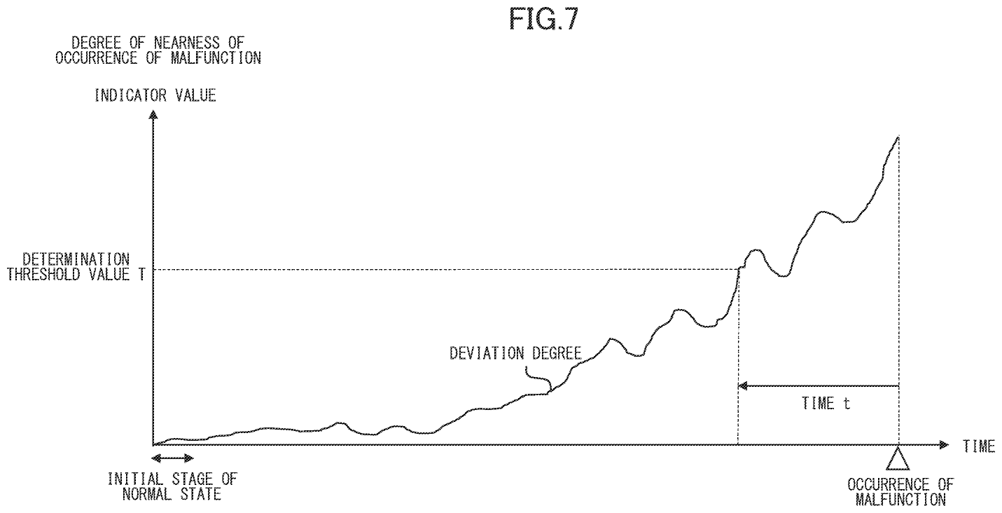

FIG. 7 is a diagram for describing a method of determining the determination threshold value in detail. In the graph of FIG. 7, the horizontal axis represents the time, and the vertical axis represents an indicator value indicating the degree of nearness of the occurrence of malfunction, that is, the deviation degree between the input and output of the post-learning model, and the graph indicates the temporal change of the indicator value from the initial stage of the normal state to the occurrence of the malfunction. To be noted, for the sake of convenience of illustration, a deviation degree obtained on the basis of the feature value corresponding to the period in which the robot was operating is shown as a graph that is temporally continuous.

A case where it is desired that an operation time equal to a predetermined time t is secured before a malfunction occurs after the malfunction prediction apparatus has predicted and notified that the occurrence of malfunction is near, that is, a case where it is desired that the malfunction prediction apparatus predicts the occurrence of malfunction at a time earlier than the occurrence of malfunction by the predetermined time t is assumed. In this case, the indicator value, that is, the deviation degree between the input and output of the post-learning model, at the time earlier than the occurrence of malfunction by the predetermined time t as illustrated is set as a determination threshold value T for malfunction prediction. This serves as a determination threshold value setting step.

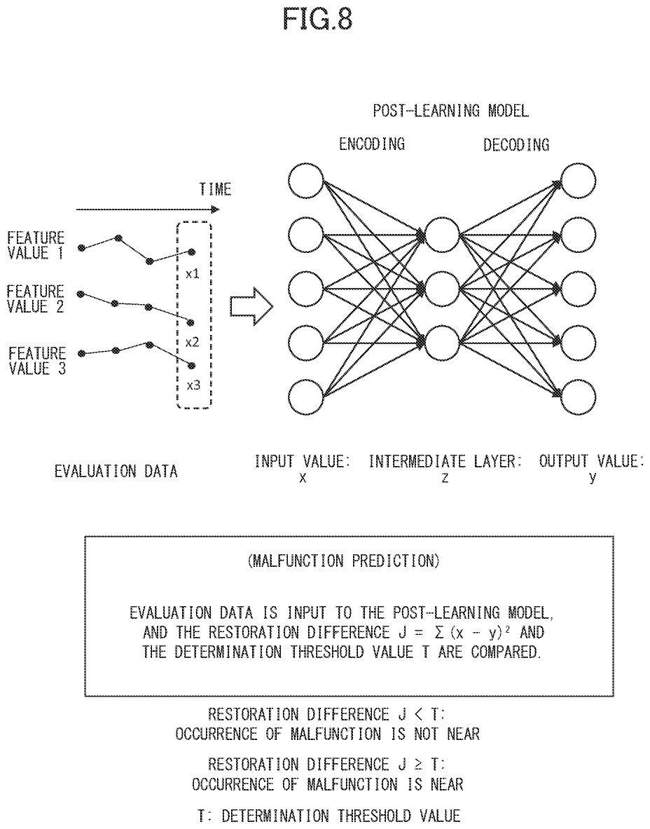

Next, a malfunction prediction method using the post-learning model and the determination threshold value described above will be described. FIG. 8 is a schematic diagram for describing the malfunction prediction method using the auto encoder.

Evaluation data indicating the operation status of the mechanical equipment at the time of evaluation is input to the post-learning model, and the deviation degree indicating how much the state of the mechanical equipment is different from the learned normal state is calculated by using the input value and output value. As the evaluation data, data of a feature value of the same kind as the feature value selected during the learning, that is, a feature value obtained by performing the same processing on measurement data of the same sensor, that corresponds to the time of evaluation and is an extracted feature value corresponding to the period in which the robot was operating is used. The period in which the robot was operating is specified by determination using the operation profile similarly to the case described for generation of the post-learning data. [00%] Specifically, the evaluation data is input to the malfunction prediction model as illustrated in FIG. 8, and the restoration difference J between the input value x and the output value y of the malfunction prediction model obtained as a result of the input is calculated and used as the deviation degree from the normal state. In the present embodiment, this deviation degree is used as the indicator value indicating the degree of nearness of the occurrence of malfunction. In the case where the deviation degree, that is, the restoration difference J is equal to or greater than the determination threshold value T, it is determined that the time to the occurrence of malfunction is equal to or shorter than the predetermined time t, that is, it is determined that there is a sign of malfunction. Conversely, in the case where the deviation degree, that is, the restoration difference J is less than the determination threshold value T, it is determined that the time to the occurrence of malfunction is longer than the predetermined time t, that is, it is determined that there is no sign of malfunction.

### Processing Procedure

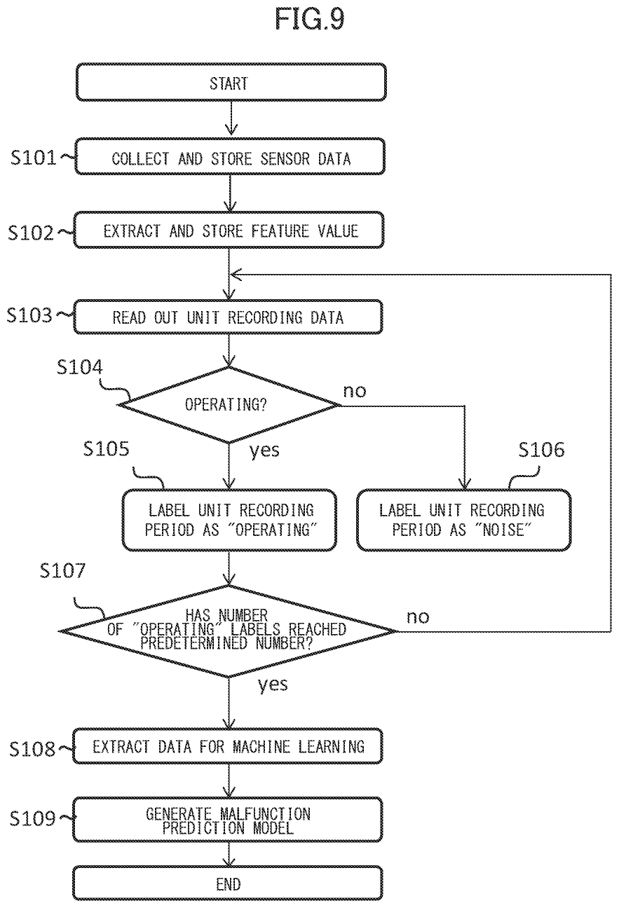

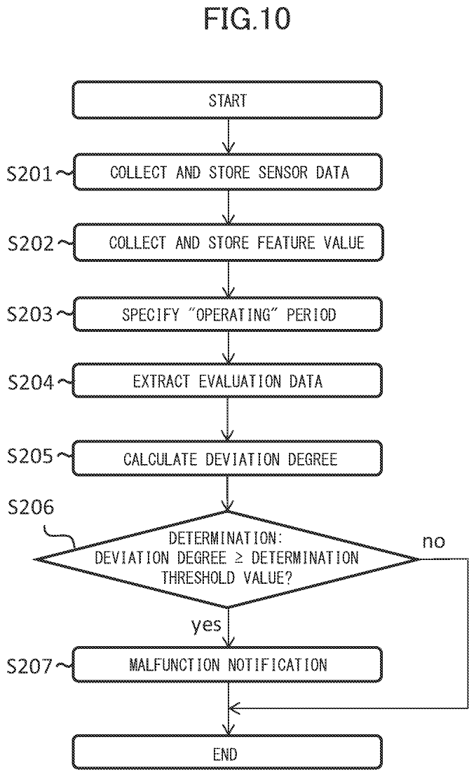

Next, the procedure of processing performed by the malfunction prediction apparatus 100 will be described with reference to flowcharts of FIGS. 9 and 10.

### Generation of Model

FIG. 9 is a flowchart illustrating the processing procedure for generating a malfunction prediction model.

First, in step S101, the sensor data collection portion 111 of the malfunction prediction apparatus 100 obtains measurement data from the sensors 11 for measuring the state of the mechanical equipment 10, and stores the measurement data in the sensor data storage portion 121. That is, a measurement value related to the mechanical equipment in the normal state is obtained in a first period. This serves as a measurement data obtaining step.

Next, in step S102, the feature value extraction portion 112 extracts a feature value indicating the characteristics of the operation status of the mechanical equipment 10 on the basis of the sensor data stored in the sensor data storage portion 121, and stores the extracted feature value in the feature value storage portion 122. This serves as a feature value extraction step.

Next, in step S103, the state determination portion 113 reads out unit recording data, that is, a unit record from the sensor data storage portion 121.

Next, in step S104, the state determination portion 113 compares the read unit recording data, that is, the unit record, with a profile stored in the operation profile storage portion 123, and determines whether the robot was operating in the unit recording period. In the case where it has been determined that the robot was operating, that is, in the case where the result of step S104 is yes, the process proceeds to step S105, and the state determination portion 113 labels the unit recording period in the calendar information as “operating”, and stores this information in the operation status determination storage portion 124. In the case where it has been determined that the unit recording period includes a non-operating period, that is, in the case where the result of step S104 is no, the process proceeds to step S106, and the state determination portion 113 labels the unit recording period in the calendar information as “noise”, and stores this information in the operation status determination storage portion 124.

Next, in step S107, whether or not the number of unit recording periods labeled as “operating” has reached a predetermined number is determined. Here, the predetermined number is a number predetermined for securing data for machine learning of an amount sufficient for generating a highly precise malfunction prediction model. In the case where the number of unit recording periods labeled as “operating” has not reached the predetermined number, that is, in the case where the result of step S107 is no, steps after step S102 are repeated. In the case where the number of unit recording periods labeled as “operating” has reached the predetermined number, that is, in the case where the result of step S107 is yes, the process proceeds to step S108.

In step S108, the data extraction portion 114 extracts a feature value from the feature value storage portion 122 on the basis of the information about the period in which the machine equipment was operating stored in the operation status determination storage portion 124 and information stored in the malfunction prediction model condition storage portion 125. The malfunction prediction model condition storage portion 125 stores, in advance, information for specifying which feature value among various feature values indicates the characteristics of the mechanical equipment in the normal state, for example, information for selecting a feature value from 9 kinds of feature values illustrated on the right side in FIG. 3. In addition, the operation status determination storage portion 124 stores information for specifying the period in which the mechanical equipment was operating. Therefore, a feature value indicating the characteristics of the mechanical equipment in the normal state is selected as data for machine learning, and moreover, only a part corresponding to the period in which the mechanical equipment was operating is extracted. This serves as a learning data extraction step. The extracted feature value is output to the malfunction prediction model generation portion 115 as data for machine learning.

Next, in step S109, the malfunction prediction model generation portion 115 generates a post-learning model, that is, a malfunction prediction model, by using the data for machine learning input from the data extraction portion 114, and stores the post-learning model in the malfunction prediction model storage portion 126. This serves as a post-learning model generation step.

A post-learning model, that is, a malfunction prediction model can be generated by performing the series of processing described above.

### Malfunction Prediction

Next, a procedure of processing performed by the malfunction prediction apparatus 100 by using the generated post-learning model, that is, the malfunction prediction model, when determining whether or not the occurrence of malfunction of the mechanical equipment 10 is near will be described.

FIG. 10 is a flowchart illustrating a processing procedure. The processing for determining whether or not the occurrence of malfunction of the mechanical equipment 10 is near is started by, for example, a user instructing the start of the processing by using the input portion 140 of the malfunction prediction apparatus 100. Alternatively, the control program of the malfunction prediction apparatus 100 may be configured such that the processing is automatically started in accordance with the operation time of the mechanical equipment 10.

When the processing is started, in step S201, the sensor data collection portion 111 of the malfunction prediction apparatus 100 obtains the measurement data from the sensors 11 that measure the state of the mechanical equipment 10, and stores the measurement data in the sensor data storage portion 121. That is, a measurement value related to the mechanical equipment in an evaluation period is obtained.

Next, in step S202, the feature value extraction portion 112 extracts a feature value indicating the characteristics of the operation status of the mechanical equipment 10 on the basis of the sensor data stored in the sensor data storage portion 121, and stores the feature value in the feature value storage portion 122.

Next, in step S203, the state determination portion 113 reads out the unit recording data, that is, the unit record from the sensor data storage portion 121, and compares the unit recording data with the profile stored in the operation profile storage portion 123. Then, the state determination portion 113 determines whether or not the robot was operating in the unit recording period thereof. In the case where it has been determined that the robot was operating, the state determination portion 113 labels the unit recording period in the calendar information as “operating”, and stores this information in the operation status determination storage portion 124. In the case where it has been determined that the unit recording period includes a non-operating period, the state determination portion 113 labels the unit recording period in the calendar information as “noise”, and stores this information in the operation status determination storage portion 124. It is desirable that steps S201 to S203 are repeated until “operating” labels of a sample number sufficient for performing malfunction prediction with high precision are secured. In the case where “operating” labels of a number sufficient for performing evaluation with high precision have been given to the calendar information, the process proceeds to step S204.

In step S204, the data extraction portion 114 extracts a feature value from the feature value storage portion 122 on the basis of the information about the period in which the machine equipment was operating stored in the operation status determination storage portion 124 and information stored in the malfunction prediction model condition storage portion 125. The malfunction prediction model condition storage portion 125 stores, in advance, information for specifying which feature value among various feature values indicates the characteristics of the mechanical equipment in the normal state, for example, information for selecting a feature value from 9 kinds of feature values illustrated on the right side in FIG. 3. In addition, the operation status determination storage portion 124 stores information for specifying the period in which the mechanical equipment was operating. Therefore, a feature value of the same kind as that used when generating the learning data is selected as the evaluation data, and moreover, only a part corresponding to the period in which the mechanical equipment was operating is extracted. This serves as an evaluation data extraction step. The extracted feature value is output to the malfunction determination portion 116 as evaluation.

Next, in step S205, the malfunction determination portion 116 inputs the feature value data for evaluation input from the data extraction portion 114 to the post-learning model, that is, the malfunction prediction model stored in the malfunction prediction model storage portion 126, and calculates the deviation degree between the input and output.

Next, in step S206, the malfunction determination portion 116 compares the calculated deviation degree with the determination threshold value, and thus determines whether or not the occurrence of malfunction of the mechanical equipment 10 is near, that is, whether or not there is a sign of malfunction.

In the case where the deviation degree is equal to or greater than the determination threshold value, that is, in the case where the result of step S206 is yes, it is determined that the occurrence of malfunction in the mechanical equipment 10 is near, and the process proceeds to step S207.

In step S207, the malfunction determination portion 116 issues a notification instruction to the malfunction notification portion 117. The malfunction notification portion 117 having received the notification instruction notifies the determination result of the malfunction determination portion 116 to the user. When performing the notification, information related to the determination may be stored in the storage portion 120 or provided to an external device through an external interface in addition to performing the notification to the user through the user interface. To perform the notification to the user, processing such as displaying the determination result on the display portion 130 of the malfunction prediction apparatus 100, outputting a voice message, or printing the determination result on a medium such as paper may be performed. When the notification to the user is completed, the process is finished.

In the case where the deviation degree is less than the determination threshold value, that is, in the case where the result of step S206 is no, it is determined that the occurrence of malfunction of the mechanical equipment 10 is not near, that is, it is determined that there is no sign of malfunction, and the process is finished. To be noted, even in the case where it has been determined that there is no sign of malfunction, this result may be notified to the user, and information related to the determination may be stored in a storage device or provided to an external device through an external interface.

As described above, in the present embodiment, for mechanical equipment that repeatedly performs the same operation but changes how to operate depending on the situations of the previous and next steps, such as a robot disposed in a manufacturing line, various feature values are extracted on the basis of measurement data of sensors. Among these feature values, a feature value suitable for machine learning of the operation of the robot in the normal state is selected.

In addition, measurement data that shows a remarkable change when the robot performs the operation is selected from the measurement data of the sensors, and profile information for specifying that the robot is in an operating state, that is, the robot is operating, is set. Then, by comparing the measurement data of an arbitrary period with the profile information, whether or not the robot was in the operating state in the period is determined. As a result of this, the data for machine learning can be generated by extracting only a feature value of a period in which the robot was in the operating state from time-series feature value data. By generating data for machine learning with less noise, a post-learning model, that is, a malfunction prediction model having higher prediction accuracy than conventional ones can be generated. In addition, also when setting a determination threshold value and when generating the evaluation data, only the feature value of the period in which the robot was in the operating state can be extracted, and therefore the accuracy of prediction of malfunction using the post-learning model, that is, the malfunction prediction model, can be increased.

### OTHER EMBODIMENTS

Embodiments of the present disclosure are not limited to the embodiment described above, and can be modified in many ways within the technical concept of the present disclosure.

For example, although a malfunction prediction model is generated by using an auto encoder by the method of so-called unsupervised learning in the embodiment described above, the present disclosure can be also applied to a case where the malfunction prediction model is generated by using a method of so-called supervised learning. The supervised learning is a method of constructing a model that predicts a result from an input, that is, a post-learning model that inductively obtains the relationship between input and output, by providing an enormous number of data sets of input and a result thereof, which is the label in this case, to a learning apparatus and causing the learning apparatus to learn the characteristics of the data sets.

In addition, although a method of using a neural network has been described as an example of machine learning in the embodiment described above, the method of machine learning is not limited to this, and for example, genetic programming, inductive logic programming, a support vector machine, or the like may be used. Although a general-purpose calculator or a general-purpose processor may be used as the apparatus that performs machine learning, high-speed processing can be performed by using a graphics processing unit having a GPGPU function, a large-scale PC cluster, or the like.

In addition, the machine learning is not limited to once, and additional learning may be performed. In this case, the additional learning is performed by extracting only a feature value of a period in which the mechanical equipment was operating.

In addition, a parameter that changes the most frequently when the mechanical equipment performs the operation is selected for the operation profile, the rotation speed of the rotary joint is just one example of this, and the parameter for determining the operation status can be appropriately selected in accordance with the type and operation of the mechanical equipment.

In addition, although the number of times the speed reaches 0 per unit time has been described as an indicator for determining that the unit recording period is an operating period or includes a non-operating period in the embodiment, the configuration is not limited to this. For example, the number of inflection points or the number extreme values per unit time may be used as the indicator.

In addition, although the malfunction prediction apparatus of the embodiment described above extracts feature values of the obtained sensor data, then specifies a period corresponding to the operating state, and extracts a feature value of the specified period from all the feature values, the processing method is not limited to this example. For example, a period corresponding to the operating state may be specified first on the basis of the sensor data, and a feature value may be extracted from only the sensor data corresponding to the specified period.

The malfunction prediction apparatus of the present disclosure can be applied to malfunction prediction of various machines and equipment such as industrial robots, service robots, and processing machines that operate under numerical control by a computer. A malfunction prediction system may be configured by integrating the mechanical equipment and the malfunction prediction apparatus, or the malfunction production apparatus may be provided as a part of the mechanical equipment.

The present disclosure can be also realized by supplying a program that realizes one or more functions of the embodiment to a system or an apparatus via a network or a recording medium and one or more processers of a computer of the system or the apparatus reading out and executing the program. In addition, the present disclosure can be also realized by a circuit that realizes one or more functions, for example, an ASIC.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2019-227419, filed Dec. 17, 2019, which is hereby incorporated by reference herein in its entirety.

What is claimed is:

1. A control method comprising:
obtaining, in a first period, a measurement value related to mechanical equipment in a first state;
specifying a period in which the mechanical equipment is in an operating state in the first period, by using the measurement value and profile information of the measurement value corresponding to a time when the mechanical equipment is in the operating state; and
extracting, as data for machine learning, a feature value based on the measurement value corresponding to the specified period which is in the first period and in which the mechanical equipment is in the operating state.

2. The control method according to claim 1, further comprising:
generating a post-learning model by machine learning using the data for machine learning; and
determining a state of the mechanical equipment at a time of evaluation by using the post-learning model.

3. The control method according to claim 2,
wherein the determination of the state of the mechanical equipment at the time of the evaluation comprises:
obtaining the measurement value related to the mechanical equipment in an evaluation period;
specifying a period in which the mechanical equipment is in the operating state in the evaluation period, by using the measurement value related to the mechanical equipment in the evaluation period and the profile information of the measurement value corresponding to a time when the mechanical equipment is in the operating state;
extracting, as an evaluation feature value, a feature value based on the measurement value corresponding to the period in which the mechanical equipment is in the operating state in the evaluation period; and
determining the state of the mechanical equipment in the evaluation period by obtaining an indicator value indicating a degree of deviation of the mechanical equipment from the first state by using the evaluation feature value and the post-learning model.

4. The control method according to claim 3, further comprising:
inputting, to the post-learning model, data of a feature value that is of the same kind as the feature value extracted as the data for machine learning and corresponds to a period in which the mechanical equipment reaches a second state from the first state;
obtaining a deviation degree between input data input to the post-learning model and output data output from the post-learning model;
setting a determination threshold value on a basis of temporal change of the deviation degree in the period in which the mechanical equipment reaches the second state from the first state; and
determining the state of the mechanical equipment in the evaluation period by using the indicator value and the determination threshold value.

5. The control method according to claim 4,
wherein the setting the determination threshold value comprises:
extracting data corresponding to the period in which the mechanical equipment is in the operating state from the data corresponding to the period in which the mechanical equipment reaches the second state from the first state; and
inputting the extracted data to the post-learning model.

6. The control method according to claim 1, wherein the operating state is a state in which the mechanical equipment is repeatedly performing a predetermined operation.

7. The control method according to claim 6,
wherein the measurement value comprises a plurality of measurement values measured by a plurality of sensors, and
wherein the profile information is set on a basis of a measurement value whose degree of change in a case where the mechanical equipment is repeatedly performing the predetermined operation is large among the plurality of measurement values.

8. The control method according to claim 1, wherein the profile information is set on a basis of a number of times the measurement value of a speed sensor reaches 0 in a unit time.

9. The control method according to claim 8, wherein the measurement value of the speed sensor that reaches 0 eight times in 10 seconds is specified as the measurement value corresponding to the period in which the mechanical equipment is in the operating state.

10. The control method according to claim 2, wherein the generating the post-learning model comprises generating the post-learning model by machine learning using an auto encoder.

11. The control method according to claim 2, wherein, in the determining the state of the mechanical equipment, a controller notifies a result of the determination.

12. A control apparatus comprising a controller configured to
obtain, in a first period, a measurement value related to mechanical equipment in a first state,
specify a period in which the mechanical equipment is in an operating state in the first period, by using the measurement value and profile information of the measurement value corresponding to a time when the mechanical equipment is in the operating state, and
extract, as data for machine learning, a feature value based on the measurement value corresponding to the specified period which is in the first period and in which the mechanical equipment is in the operating state.

13. Mechanical equipment comprising:
a control apparatus comprising a controller configured to
obtain, in a first period, a measurement value related to mechanical equipment in a first state,
specify a period in which the mechanical equipment is in an operating state in the first period, by using the measurement value and profile information of the measurement value corresponding to a time when the mechanical equipment is in the operating state, and
extract, as data for machine learning, a feature value based on the measurement value corresponding to the specified period which is in the first period and in which the mechanical equipment is in the operating state.

14. A method of manufacturing a product by using the mechanical equipment according to claim 13.

15. A non-transitory computer-readable recording medium storing a control program for executing a control method, the control method comprising
obtaining, in a first period, a measurement value related to mechanical equipment in a first state;
specifying a period in which the mechanical equipment is in an operating state in the first period, by using the measurement value and profile information of the measurement value corresponding to a time when the mechanical equipment is in the operating state; and
extracting, as data for machine learning, a feature value based on the measurement value corresponding to the specified period which is in the first period and in which the mechanical equipment is in the operating state.
